(19) United States
(12) Patent Application Publication
(10) Pub. No.: US 2006/0222139 A1
(43) Pub. Date: Oct. 5, 2006

(54) Methods for demonstrating moderator exclusion for nuclear criticality safety

(75) Inventor: Charles W. Pennington, Alpharetta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: NAC International, Inc.

(21) Appl. No.: 11/092,261

(22) Filed: Mar. 29, 2005

(51) Int. Cl. G21C 19/00

(52) U.S. Cl. 376/272

(57) ABSTRACT

Disclosed are methods for assuring that requirements for fissile material transportation are met to comply with the double contingency principle for preventing nuclear criticality by excluding moderator in-leakage. In one embodiment, a method includes designing and fabricating a canister to achieve an acceptable application, and verifying pre-shipment operation to assure that a transport system is properly assembled to meet its licensed transport configuration.

### TECHNICAL FIELD

The present invention relates to preventing nuclear criticality, and more particularly, the embodiments relate to methods for assuring that requirements are met to comply with the double contingency principle for preventing nuclear criticality through demonstrating that moderator materials will be excluded under normal and accident conditions.

### BACKGROUND OF THE DISCLOSURE

Dry nuclear spent fuel transport technology is deployed throughout the world to assure the capabilities of nuclear power plants to discharge and ship spent fuel away from the plant, thereby preventing loss of spent fuel storage capacity and preserving the planned operating lives of the power plants. Additionally, other fissile materials and waste forms are also transported worldwide to support and sustain many varied forms of commerce associated with fissionable heavy nuclides having atomic numbers greater than 230. The transport of fissile materials, such as spent nuclear fuel, and the packaging systems which are used to accomplish such transport must comply with rigorous regulatory requirements for design and operation to preclude release of radioactive materials to the environment and to prevent inadvertent nuclear criticality from occurring within the packaging as the result of closure (seal) failures, which could allow the ingress of neutron moderation material, such as water, to enhance the potential for the production of thermalized neutrons and the occurrence of nuclear criticality.

For dry spent nuclear fuel and other fissile material transport, two fundamental classes of technology are used: (i) metal casks with final closure lids (or lid) that are bolted closed at power plants or other facilities after loading of the material, such as spent fuel, into open compartments of a separate structure nested within the cask body (termed the “basket”); this technology when used for spent fuel shipment is termed “bare fuel” transport; and (ii) similar metal casks with bolted final closure lids (or lid) having a metal canister within the cask body which contains the basket structure and which also has a canister final closure lid (or lids) that is welded or bolted closed at the power plants or other facility following spent fuel loading; this technology when used for spent fuel shipment is called “canistered fuel” transport. This canistered material transport technology offers the capability to assure that the normal and hypothetical accident conditions imposed as part of the licensing requirements under the Code of Federal Regulations (CFR) cannot result in credible failures that would allow ingress of neutron moderator materials or egress of radioactive materials, and this technology has applicability to the transport of all types of fissile materials and forms of nuclear waste.

### Regulatory Requirements and Application

Canistered material transport technology and designs should comply with federal regulatory requirements, among which are requirements pertaining to containment, sealing, inspection, and evaluation or testing. In particular, the Code of Federal Regulations (CFR) provides that under both normal and hypothetical accident conditions (see 10 CFR 71.73), the transport system design should assure that nuclear criticality cannot occur, even if parts of the system are flooded and surrounded by water to the most reactive and reflective credible extent and the spent fuel is in its most reactive credible configuration consistent with the form of the material (see 10 CFR 71.55(b), (d) and (e)). However, the CFR also permits alternative transport system designs to be approved and used if the system incorporates special design features to ensure that the most reactive moderation is not credible, or that “no single packaging error” would permit water (moderator) in-leakage and if appropriate measures are taken before each shipment to ensure that the containment boundary (which contains the spent fuel or fissile material contents) portion of the transport system does not leak (see10 CFR 71.55(c)).

These alternative approaches within the CFR apply a long-standing, time-tested protocol within the discipline of nuclear criticality safety design and control systems. This protocol is called the “double contingency principle”, and it is defined in the CFR to mean that “. . . designs should incorporate sufficient factors of safety to require two unlikely, independent, and concurrent changes in process conditions before a criticality accident is possible.” (see 10 CFR 70.4). Thus, following an initiating event of the CFR-prescribed hypothetical accident conditions (see 10 CFR 71.73), the CFR allows for approval of transport system designs that can reasonably assure no single error or failure would permit water ingress and that have operational provisions prior to shipment that reasonably assure the containment system does not leak.

Thus, a heretofore unaddressed need exists in the industry for apparatus and methods to satisfy the aforementioned codes, standards, and regulatory requirements.

### SUMMARY OF THE DISCLOSURE

Disclosed are methods for assuring that requirements are met for fissile material transportation to comply with the double contingency principle by excluding moderator in-leakage. In one embodiment, among others, a method includes designing and fabricating a canister to achieve an acceptable application, and verifying pre-shipment operation to assure that a transport system is properly assembled to meet its licensed transport configuration.

Other methods, features, and advantages of the present invention will be or become apparent to one with skill in the art upon examination of the following drawings and detailed description. It is intended that all such additional methods, features, and advantages included within this description, be within the scope of the present invention, and be protected by the accompanying claims.

### BRIEF DESCRIPTION OF THE DRAWINGS

The disclosed methods can be better understood with reference to the following drawings. The components in the drawings are not necessarily to scale.

FIG. 1 is a partially cut-away, perspective view of an embodiment of a canister that stores and transports nuclear spent fuel.

FIG. 2 is a diagram that illustrates a transport cask on a shipping cradle to transport a canister from one location to another.

FIG. 3 is a flow diagram that illustrates an embodiment of operation of a process for assuring that requirements are met to comply with moderator exclusion for preventing nuclear criticality.

FIGS. 4A-B are flow diagrams that show details of one embodiment of the step of designing the canister shown in FIG. 3.

FIG. 5 is a flow diagram that shows details of one embodiment of the step of fabricating the canister with closure installation shown in FIG. 3.

FIG. 6 is a flow diagram that shows details of one embodiment of the step of welding the canister closure to seal the canister shown in FIG. 5.

FIG. 7 is a flow diagram that shows details of one embodiment of the step of verifying pre-shipment operation shown in FIG. 3.

FIG. 8 is a flow diagram that shows details of one embodiment of the step of verifying pre-shipment operation shown in FIG. 4.

### DETAILED DESCRIPTION OF THE PREFERRED EMBODIMENT

Under the Code of Federal Regulations (CFR) requirements for the transport of spent fuel and other fissile materials, the metal transport cask provides the containment boundary for the approved contents. Therefore, the metal cask body and its closure system provide one level of fissile material containment that meets the CFR. Disclosed herein is a method to assure that a canister system, enclosed within a metal cask complying with the CFR requirements, provides a total system with the necessary and sufficient design features and other conditions for a second level of fissile material containment, such that the double contingency principle can be achieved as stipulated within the CFR to assure exclusion of neutron moderator following the application of both normal and hypothetical accident conditions to the transport system.

Exemplary canisters and metal transport casks are first discussed with reference to the figures. Although the exemplary canisters and metal transport casks are described in detail, they are provided for purposes of illustration only and various modifications are feasible. After the exemplary canisters and metal transport casks have been described, examples of application of the method are explained to assure that requirements are met for the exclusion of moderator in-leakage.

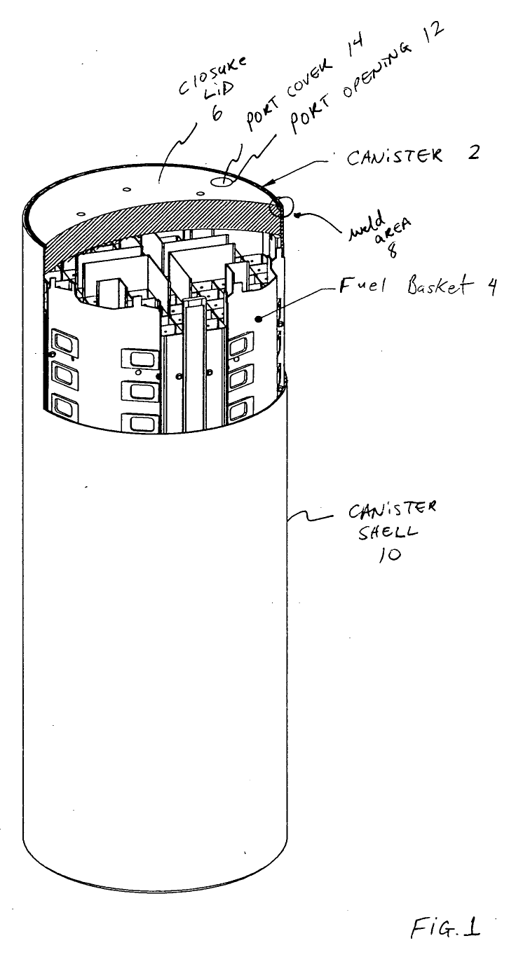

Referring now in more detail to the figures in which like reference numerals identify corresponding parts, FIG. 1 is a partially cut-away, perspective view of an embodiment of a canister that stores and transports nuclear spent fuel. The canister 2 can be a single closure lid design of a canister-based dry storage technology, which is disclosed in U.S. patent application Ser. No. 11/034,622 and is hereby incorporated by reference in its entirety. The canister 2 can include one closure lid 6 and one weld area 8. The use of a single closure lid design is one approach to achieving redundant sealing of the confinement system for “field closure” of the canister 2 following loading with nuclear spent fuel or other desired content.

The canister 2 includes a canister shell 10. In an alternative embodiment, the closure lid 6 can include a port opening 12 that is adapted to receive a port cover 14 and a drain or vent member (not shown). In an alternative embodiment, the canister I can include a basket assembly 4 that is preferably disposed in the canister shell 10 before the canister is sealed. In an alternative embodiment, the canister 2 can further include a seal ring (not shown) that is disposed between the canister shell 10 and the closure lid 2, at the inner circumference of the canister shell 10 and at the outer circumference of the closure lid 6. The seal ring can be a single piece or multiple pieces.

The single closure lid design of the canister 2 can comply with the requirements as stipulated within the CFR to assure exclusion of neutron moderator.

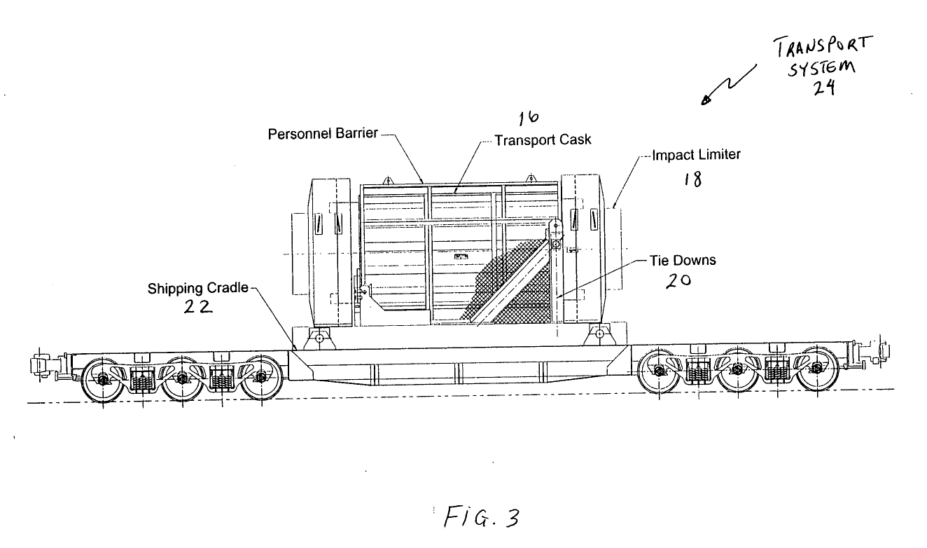

Other canister designs, besides the single closure lid design, can also comply with the CFR requirements if the canister design and the canister fabrication with closure installation achieve acceptable application, as disclosed in FIGS. 3-6.

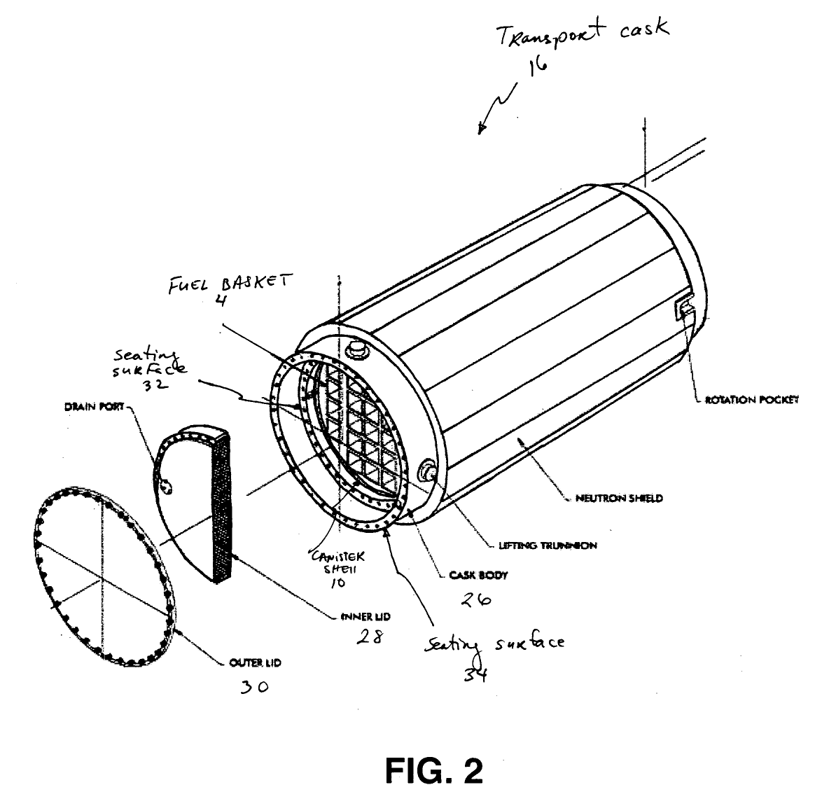

FIG. 2 is a diagram that illustrates a transport cask that transports a canister from one location to another. The transport cask 16 includes a cask body 26, an inner lid 28, and an outer lid 30. A canister having a fuel basket 4 can be placed in the cask body 26 of transport cask 16. The inner lid 28 is placed inside the cask body 26 and may engage the seating surface 32 of the transport cask 16 wherein the outer circumference of the inner lid 28 is adjacent to the inside wall of the cask body 26.

Alternatively, the inner lid 28 may be attached to the canister. The inner lid 28 is attached to the transport cask 16 or to the canister by way of, for example, welding, bolting, or any other attaching means. The outer lid 30 is placed on top of the cask body 26 and engages seating surface 34 of the transport 16. The outer circumference of the outer lid 30 substantially aligns with the outside wall of the cask body 26. As may be the case with the inner lid 28, the outer lid 30 may be attached to the transport cask 16 by way of, for example, welding, bolting, or any other attaching means.

FIG. 3 is a diagram that illustrates a transport system 24 having a transport cask on a shipping cradle to transport a canister from one location to another. The transport cask 16 includes an impact limiter 18 at the ends of the transport cask 16 and tie-downs 20 restricting the transport cask 16 from rolling off a shipping cradle 22.

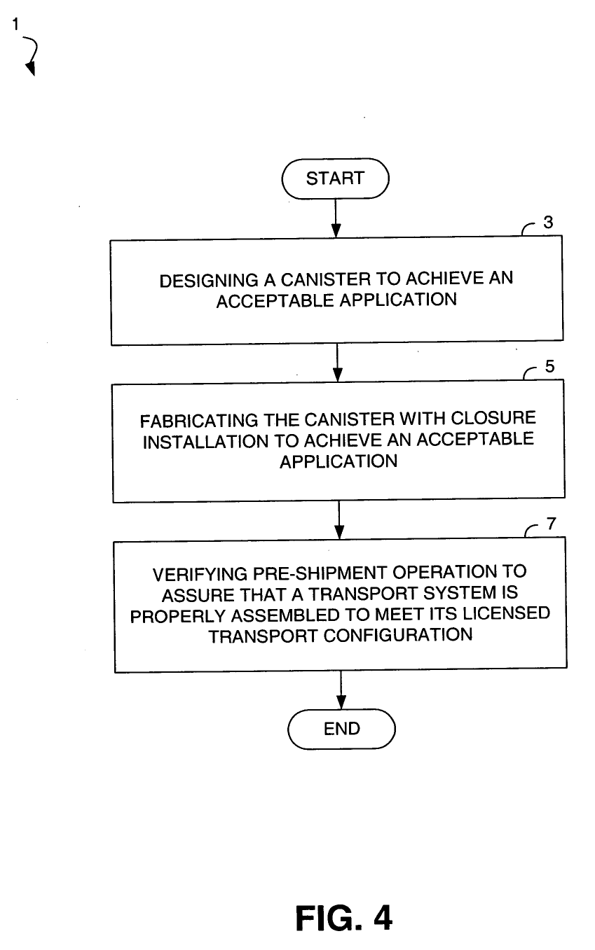

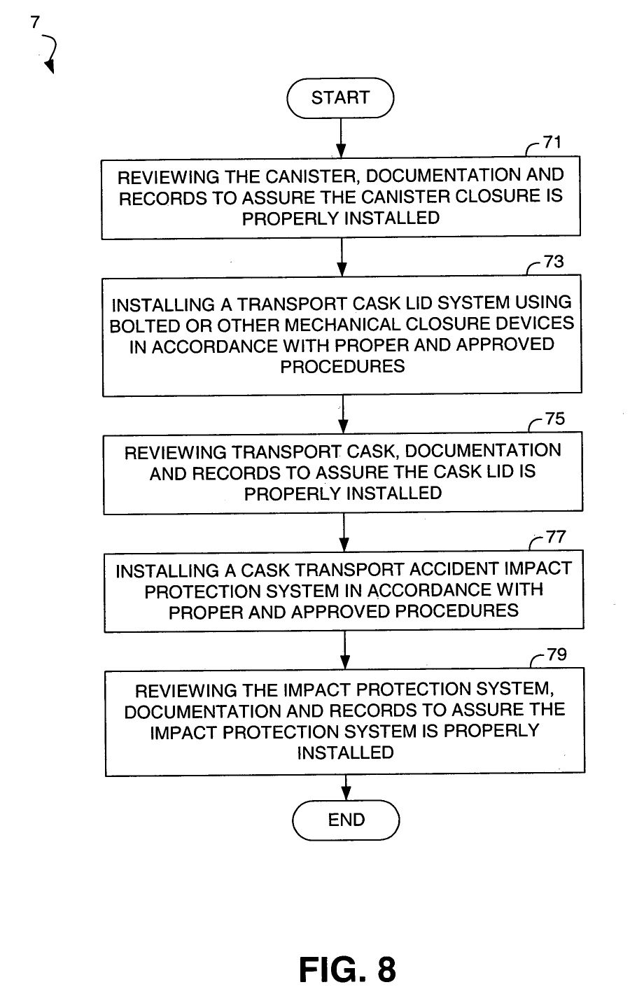

The tie-downs 20 mechanically secure the transport cask 16 to the shipping cradle 22, which transports the canister 2 from a power plant (not shown) to a remote facility (not shown). A verifying pre-shipment operation is described below in FIGS. 4 and 8 to assure that a transport system 24 is properly assembled to meet its licensed transport configuration.

The flow charts described hereafter show the architecture, functionality, and application of a method for assuring that requirements are met to comply with the CFR and achieve moderator exclusion to prevent nuclear criticality. It should also be noted that in some alternative implementations, the functions noted in the blocks may occur out of order. For example, two blocks shown in succession in FIG. 4 may, in fact, be executed substantially concurrently or the blocks may sometimes be executed in the reverse order, depending upon the functionality involved, as will be further clarified hereinbelow.

FIG. 4 is a flow diagram that illustrates an embodiment of the application of a method for assuring that requirements are met to comply with the CFR and achieve moderator exclusion. In block 3, the method 1 includes designing a canister 2 to achieve an acceptable application and in block 5, fabricating the canister 2 with closure installation to achieve acceptable application. In block 7, the method further includes verifying pre-shipment operation to assure that a transport system 24 is properly assembled to meet its licensed transport configuration. The canister system design and the performance of its fabrication and closure at the power plant or other facility, together with the operational verification provisions prior to shipment, form the categories of the sufficient conditions for the preferred embodiment of the disclosed method.

### Canister System Design

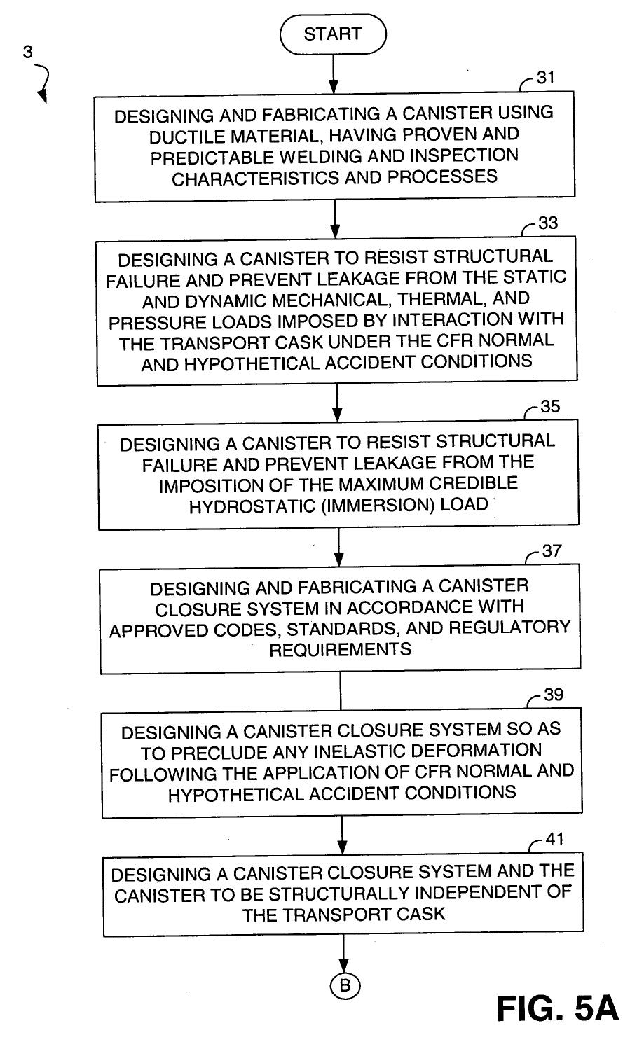

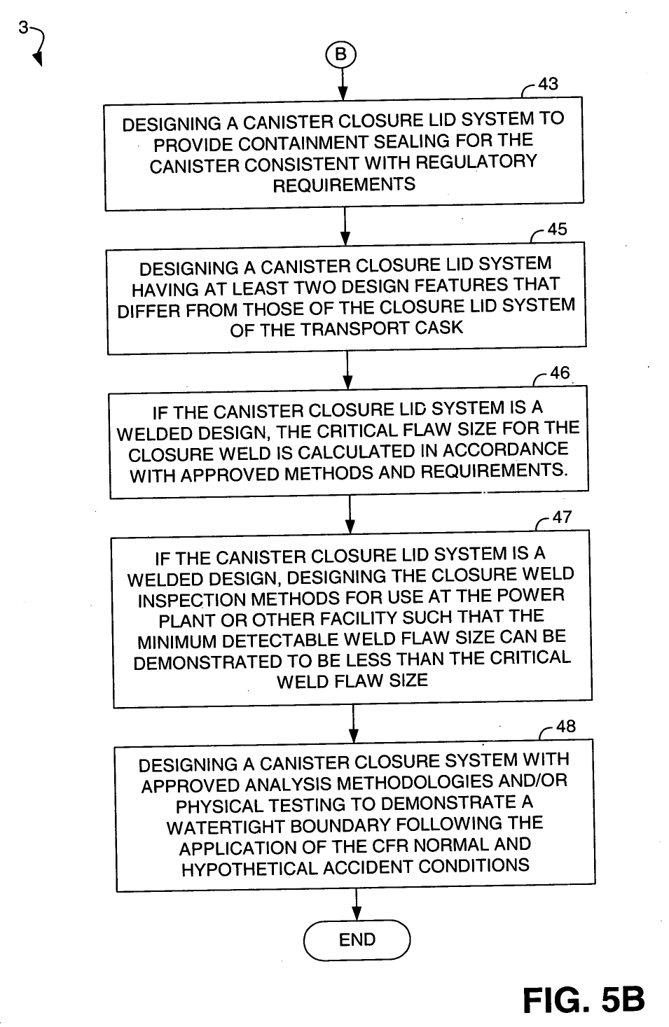

FIGS. 5A-B are flow diagrams that show details of one embodiment of the step of designing the canister 2 shown in FIG. 4. Referring to FIG. 5A, in block 31, the step 3 of designing the canister 2 includes designing and fabricating the canister 2 using ductile material, such as austenitic stainless steel, having proven and predictable welding and inspection characteristics and processes. In block 33, the canister 2 is designed to resist structural failure and prevent leakage from the static and dynamic mechanical, thermal, and pressure loads imposed by interaction with the transport cask 16 under the CFR hypothetical drop, puncture, and thermal accident conditions. In block 35, the canister 2 is designed to resist structural failure and prevent leakage from the imposition of the maximum credible hydrostatic (immersion) load, together with the load duration, that may occur following the application of CFR hypothetical accident conditions.

In block 37, the canister closure system is designed and fabricated in accordance with approved codes, standards, and regulatory requirements. If the closure is a welded lid system, then the lid structure must be designed for the weld depth and type requirements of the closure design, as well as those of applicable regulations, codes and standards. In block 39, the canister closure system is designed so as to preclude any inelastic deformation following the application of CFR hypothetical accident conditions. In block 41, the canister and its closure lid system is designed to be structurally independent of the transport cask 16, in that the canister system 2 is not part of the metal cask body and there is no structural connection between the canister 2 and transport cask 16. The canister 2 may rely only upon pure contact with the transport cask body.

Referring now to block 43 in FIG. 5B, the canister closure lid system should be designed to provide regulatory containment sealing for the canister. In block 45, the canister closure lid system should be of a technology or design having at least two design features that differ from the closure lid system of the transport cask 16. The two design features may include, but are not limited to, the material that forms the containment seal, the technology that is used to make the sealing material effective, the types of bolting or other mechanical force closure methods that may be used to seat the lids and seals, and the number of separate lids that are part of the closure lid system. This assures the disclosed method is highly resistant to common mode failures.

In block 46, if the canister closure lid system is a welded design, the critical flaw size for the closure weld is calculated in accordance with approved methods and requirements. In block 47, if the canister closure lid system is a welded design, the closure weld inspection methods for use at the power plant or other facility are designed such that the minimum detectable weld flaw size can be demonstrated to be less than the critical weld flaw size. In block 48, the canister closure system is designed to be a watertight boundary following the application of the CFR hypothetical accident conditions, which can be shown by approved analysis methodologies and/or physical testing.

### Performance of Canister System Fabrication and Closure

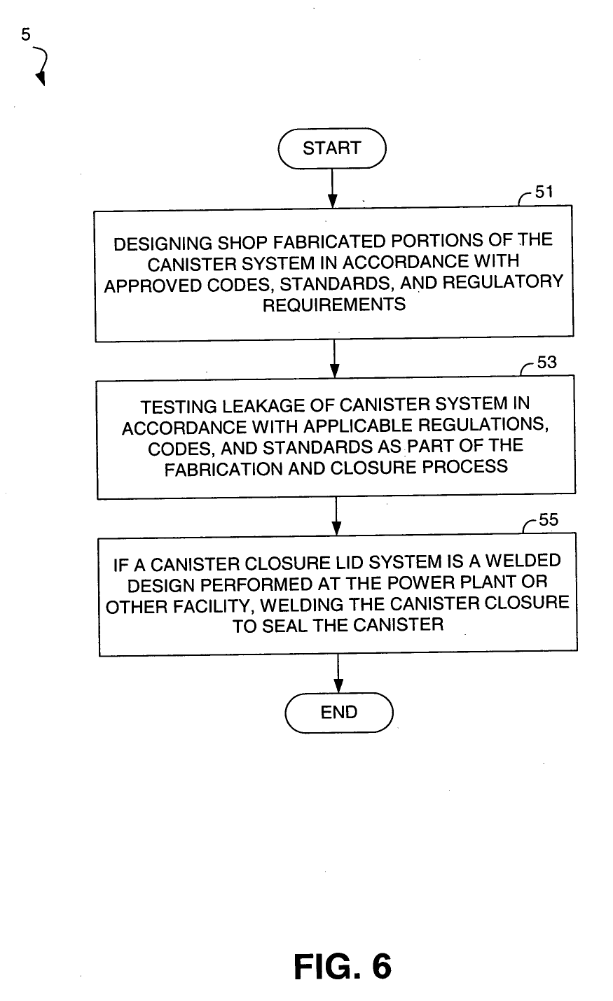

FIG. 6 is a flow diagram that shows details of one embodiment of the step of fabricating the canister 2 with closure installation shown in FIG. 1. In block 51, the step 5 of fabricating the canister 2 includes designing the shop fabricated portions of the canister system in accordance with approved design requirements, as well as applicable regulations, codes, and standards. In block 53, the canister system is leak tested in accordance with applicable regulations, codes, and standards as part of the fabrication and closure process. In block 55, if the canister closure lid system is a welded design performed at the power plant or other facility, the weld becomes the seal for the canister closure, which is further described below in relation to FIG. 4.

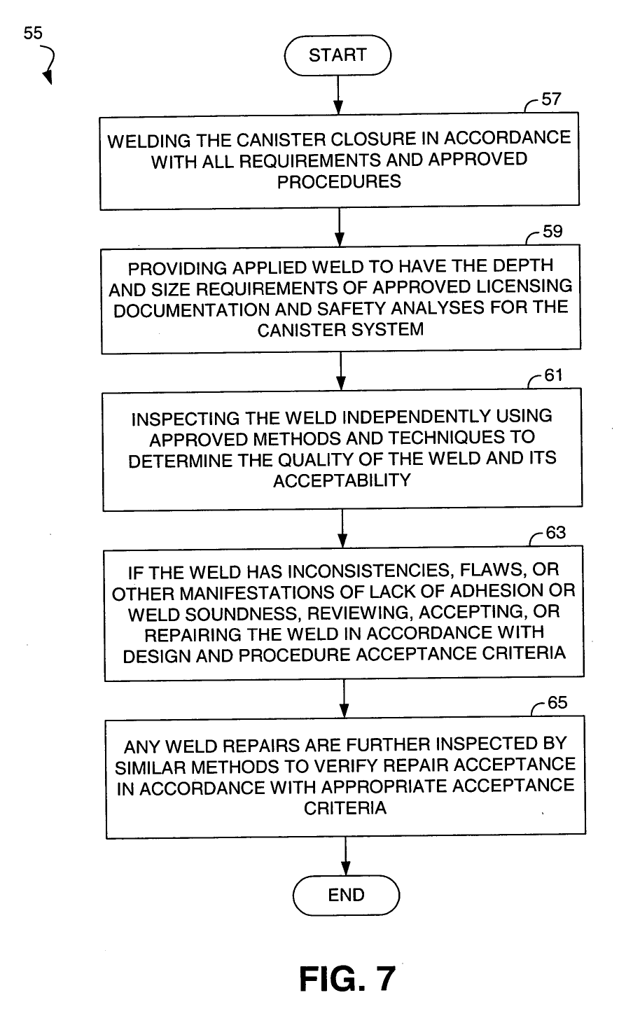

FIG. 7 is a flow diagram that shows details of one embodiment of the step of welding the canister closure to seal the canister shown in FIG. 6. In block 57, the step 55 of welding the canister closure includes welding the canister in accordance with requirements and approved procedures. In block 59, the applied weld has the depth and size requirements of approved licensing documentation and safety analyses for the canister system. In block 61, the weld is independently inspected using approved methods and techniques to determine the quality of the weld and its acceptability. In block 63, any weld inconsistencies, flaws, or other manifestations of lack of adhesion or weld soundness are reviewed, accepted, or repaired in accordance with design and procedure acceptance criteria. In block 65, any weld repairs are further inspected by similar methods to verify repair acceptance in accordance with appropriate acceptance criteria.

### Performance of Pre-Shipment Confirmatory Verifications

FIG. 8 is a flow diagram that shows details of one embodiment of the step of verifying pre-shipment operation shown in FIG. 4. Prior to the shipment of spent fuel or other fissile material in a transportation system, various tasks are performed to assure that the transport system 24 is properly assembled to meet its licensed transport configuration. Prior to pre-shipment operation, it is demonstrated by documentation of the previous operations that the installation of the canister closure has been performed by approved and compliant methods. In block 71, the step 7 of verifying pre-shipment operation includes reviewing and verifying the canister and its documentation and records to assure the canister closure is properly installed. This provides verification that a first level of independent containment is in-place.

In block 73, the installation of the transport cask lid system using bolted or other mechanical closure devices is performed in accordance with proper and approved procedures. In block 75, an additional review and approval of the completed process and its documentation and records become the verification of the transport cask configuration, and are performed to assure the cask lid is properly installed. This provides verification that a second level of independent containment is in place. In block 77, a cask transport accident impact protection system is installed in accordance with proper and approved procedures, and in block 79, an additional review and approval of the completed process and its documentation and records become the verification of the impact protection system configuration, and are performed to assure the impact protection system is properly installed. This provides verification that the impact protection system, which moderates accident loads on both levels of containment, is properly configured. A reduction of the impact protection system effectiveness could result in a common mode failure that may affect both containment systems, and this is precluded by proper performance of such verfications.

The proper performance of the steps 3, 5, and 7, involving the internal canister design, canister fabrication with closure installation, and pre-shipment operational verifications, constitutes the disclosed method 1 to assure that requirements are met to comply with the CFR to preclude moderator ingress into fissile material transport packagings under normal or following hypothetical accident conditions.

It should be emphasized that the above-described embodiments of the present invention, particularly, any “preferred” embodiments, are merely possible examples of implementations, set forth for a clear understanding of the principles of the invention.

Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A method for an approach that meets the double contingency principle to assure moderator exclusion to prevent nuclear criticality, the approach incorporating sufficient factors of safety to require two unlikely, independent, and concurrent changes in process conditions before a criticality accident is possible, the method comprising:
incorporating in the approach to meet the double contingency principle an assumption that the transport cask allows moderator ingress;
nullifying the effects of the assumption that the transport cask allows moderator ingress in the approach to achieve the double contingency principle, wherein by nullifying the effects of the assumption that the transport cask allows moderator ingress, usage of materials placed inside the canister to absorb moderated neutrons is reduced in comparison to the situation where moderator ingress into the canister is assumed, thereby reducing the cost of safe nuclear spent fuel transport: the steps of nullifying are accomplished by:
designing a canister to achieve an application of the double contingency principle to assure moderator exclusion from the canister fuel region,
providing procedures for fabricating and closing the canister with closure installation to achieve the double contingency principle approach, the closure installation having closure lid weld redundancy, and
providing procedures for leakage testing of the canister system; and
providing procedures for enclosing the fabricated canister within the transport cask; and
providing procedures for verifying pre-shipment assembly operations to assure that a transport system is properly assembled to meet the as-designed transport configuration.

2. The method as defined in claim 1, wherein designing the canister comprises designing and fabricating the canister using ductile material.

3. The method as defined in claim 2, wherein the ductile material is austenitic stainless steel.

4. The method as defined in claim 1, wherein designing the canister comprises designing the canister to resist structural failure and prevent leakage from the static and dynamic mechanical, thermal, and pressure loads imposed by interaction with the transport cask.

5. The method as defined in claim 1, wherein designing the canister comprises designing the canister to resist structural failure and prevent leakage from the imposition of a hydrostatic load.

6. The method as defined in claim 1, wherein the closure lid weld redundancy of the canister is achieved by:
welding a closure lid to the canister at a weld area that forms a first weld layer to close the canister; and
welding the closure lid to the canister at the weld area that forms a second weld layer substantially on top of the first weld layer to close the canister.

7. The method as defined in claim 1, wherein designing the canister comprises designing a canister closure system so as to preclude any inelastic deformation.

8. The method as defined in claim 1, wherein designing the canister comprises designing a canister closure system and the canister to be structurally independent of the transport cask.

9. The method as defined in claim 1, wherein designing the canister comprises designing a canister closure lid system to provide containment sealing for the canister.

10. The method as defined in claim 1, wherein designing the canister comprises designing a canister closure lid system having at least two design features that differ from those of the closure lid system of the transport cask, the design features including one of the following: materials that form the containment seal, technologies that are used to make the sealing material effective, types of bolting or other mechanical force closure methods that are used to seat the lids and seals, and the number of separate lids that are Dart of the closure lid system.

11. The method as defined in claim 1, wherein designing the canister comprises designing a canister closure system by physical testing to demonstrate a watertight boundary.

12. The method as defined in claim 1, wherein fabricating the canister with closure installation comprises assuring shop fabricated portions of the canister system meet each level of system closure design.

13. The method as defined in claim 1, wherein fabricating the canister with closure installation comprises testing leakage of the canister system as part of the fabrication and closure process.

14. The method as defined in claim 1, wherein fabricating the canister with closure installation comprises welding the canister closure to seal the canister after loading at the power plant or other facility if a canister closure lid system is a welded design.

15. The method as defined in claim 14, wherein welding the canister closure comprises:
welding the canister closure;
providing applied weld to have the depth and size requirements the as-designed canister system;
inspecting the weld independently to determine the quality of the weld;
reviewing, accepting, or repairing the weld if the weld has inconsistencies, flaws, or other manifestations of lack of adhesion or weld soundness; and
verifying weld repairs.

16. The method as defined in claim 1, wherein verifying pre-shipment operation comprises reviewing the canister and its documentation and records to assure the canister closure is properly installed.

17. The method as defined in claim 1, wherein verifying pre-shipment operation comprises installing a transport cask lid system using bolted or other mechanical closure devices.

18. The method as defined in claim 1, wherein verifying pre-shipment operation comprises reviewing the transport cask and its documentation and records to assure the cask lid is properly installed.

19. The method as defined in claim 1, wherein verifying pre-shipment operation comprises installing a cask transport accident impact protection system.

20. The method as defined in claim 1, wherein verifying pre-shipment operation comprises reviewing the impact protection system and its documentation and records to assure the impact protection system is properly installed
